(19) United States
(12) Patent Application Publication
(10) Pub. No.: US 2011/0294916 A1
(43) Pub. Date: Dec. 1, 2011

(54) HYDROPHILIC MARKING FILM HAVING PLASMA CHEMICAL VAPOR DEPOSITION TREATED PROTECTIVE LAYER

(75) Inventors: Hidetoshi Abe, Tendo-city (JP); Naoyuki Toriumi, Sagamihara-city (JP); Moses M. David, Woodbury, MN (US)

(73) Assignee: 3M Innovative Properties Company

(21) Appl. No.: 12/787,918

(22) Filed: May 26, 2010

(51) Int. Cl. F21V 7/22

(52) U.S. Cl. 523/172

(57) ABSTRACT

The present application relates to a hydrophilic marking film having both hydrophilicity at the time of application and stable hydrophilicity over time, the hydrophilic marking film having excellent weather resistance properties such as color difference, gloss retention, and the like, and excellent contamination resistance properties. The hydrophilic marking film is provided with a film and a protective layer, wherein the protective layer contains 10% or more but less than 40% of carbon, more than 45% but not more than 75% of oxygen and 15% or more but not more than 32% of silicon in terms of atomic composition and is formed by a plasma CVD method.

The present disclosure generally relates to a hydrophilic marking film having a plasma chemical vapor deposition treated protective surface, and more specifically relates to a hydrophilic marking film having both hydrophilicity at the time of application and stable hydrophilicity over time, the hydrophilic marking film having excellent weather resistance properties such as color difference, gloss retention, and the like, and excellent contamination resistance properties.

### BACKGROUND

Marking films are used in a variety of applications, such as outdoor signs, vehicle decoration, graphics, advertising and surface decorations. Because marking films are often used for long periods out of doors, the contamination resistance properties of the surface of marking films are improved by various means; one means of improving the contamination resistance properties is to dispose a hydrophilic protective layer on a surface thereof. Because the surface of a hydrophilic marking film has a low contact angle with water, any adhered oleophilic contaminants can be rinsed off by rain water and the like. In addition, because the surface is readily wetted with water, hydrophilic contaminants can be easily removed through natural cleaning by rain water and the like or through artificial cleansing methods.

Various types of hydrophilic protective surface are known. For example, WO 2001/083633 describes “an adhesive sheet comprising a flexible substrate, an adhesive layer disposed on the back surface of said flexible substrate, and a protective layer disposed on the surface of said flexible substrate, characterized in that: said protective layer contains a cured resin, and a hydrophilizing agent of an inorganic oxide, an organosilicate compound or a mixture thereof and that the thickness of said protective layer is from about 0.1 to about 60 μm and the contact angle between the surface of said protective layer and water is from about 35° to about 65°.”

Japanese Patent Application Publication No. 2000-109580 describes an “antifouling member, wherein a resin layer comprising an inorganic resin containing a siloxane bond is formed on a surface of the member and the surface of the resin layer is subjected to one or a combination of two or more hydrophilization treatments selected from the group consisting of corona discharge treatment, plasma discharge treatment, ultraviolet irradiation treatment, or the like so as to impart the surface of the member with hydrophilicity.”

Japanese Patent Application Publication No. 2003-306563 describes a “stainproof film, wherein one side of a film substrate is subjected to plasma discharge treatment and is coated with a water-based stainproofing agent containing titanium oxide.”

Japanese Patent Application Publication No. 2004-107573 describes a “hydrophilic film, wherein a blended solution comprising hydrophilic inorganic particles, minute polymer particles dispersed in an aqueous medium, and a reactive organic fluorine compound is applied to a surface of a substrate resin formed into a film shape and dried to form a coating layer, and the surface of the coating layer is then subjected to corona treatment.”

However, because conventional hydrophilic protective layers require time for the hydrophilicity to become active, there is a need for a protective layer that exhibits hydrophilicity at the time of application.

Furthermore, a plasma CVD method is known in which chemical interactions are caused by the radicalization of a deposition film-forming gas in the vicinity of a surface of a substrate through the use of high frequency wave or microwave energy, thereby depositing a film on the surface of the substrate.

For example, Japanese Patent Application Publication No. 2002-113805 describes a “water-repellent stainproof film, having a surface silica layer formed according to a CVD method, comprising the elements of silicon, oxygen, and carbon, containing from 20 to 50 atomic % of carbon, having a surface energy of from 20 to 40 mN/m, and having a contact angle with water of from 70° to 110°.”

WO 2001/066820 describes an “article provided with a film including a diamond-like glass containing at least 30 atomic % of carbon, at least 25 atomic % of silicon, and not more than 45 atomic % of oxygen.”

### SUMMARY

The present inventors recognized a need for a hydrophilic marking film that both exhibits hydrophilicity at the time of application and displays little deterioration of hydrophilicity over time. The present inventors also recognized a need for a hydrophilic marking film with excellent weather resistance properties such as color difference, gloss retention, and the like.

One object of the present application is to provide a hydrophilic marking film having both hydrophilicity at the time of application and stable hydrophilicity over time, the hydrophilic marking film having excellent weather resistance properties such as color difference, gloss retention, and the like, and excellent contamination resistance properties.

Another object of the present application is to provide a hydrophilic marking film able to be used on curved substrates without any reduction in followability with regards to curved surfaces after being rendered hydrophilic. Such hydrophilic marking films have excellent curved surface followability, and are therefore very useful for applications such as vehicles and wall surfaces.

One exemplary embodiment of the present application includes a hydrophilic marking film provided with a film and a protective layer, wherein the protective layer contains 10% or more but less than 40% of carbon, more than 45% but not more than 75% of oxygen and 15% or more but not more than 32% of silicon in terms of atomic composition, and the protective layer is formed by a plasma CVD method.

Another exemplary embodiment of the present application is a hydrophilic marking film provided with a film and a protective layer, wherein the protective layer contains 10% or more but less than 40% of carbon, more than 45% but not more than 75% of oxygen and 15% or more and not more than 32% of silicon in terms of atomic composition, and the protective layer is formed by a plasma CVD method having two or more steps.

Another exemplary embodiment of the present application provides a traffic sign utilizing any of the hydrophilic marking films described above.

### BRIEF DESCRIPTION OF THE DRAWINGS

FIG. 1 shows a cross section of one embodiment of a hydrophilic marking film in accordance with the present disclosure.

FIG. 2 shows one embodiment of a system for depositing a protective layer according to the plasma CVD Method.

### DETAILED DESCRIPTION

The present application describes a hydrophilic marking film exhibiting both hydrophilicity at the time of application and stable hydrophilicity over time. The present application also describes a hydrophilic marking film having excellent weather resistance properties such as color difference, gloss retention, and the like, and excellent contamination resistance properties.

The hydrophilic marking film of the present application includes hydrophilic marking films that exhibit hydrophilicity when applied to substrates such as building wall surfaces, outdoor signs and outdoor traffic signs and that resist any significant increase in contact angle with water even after the passage of time.

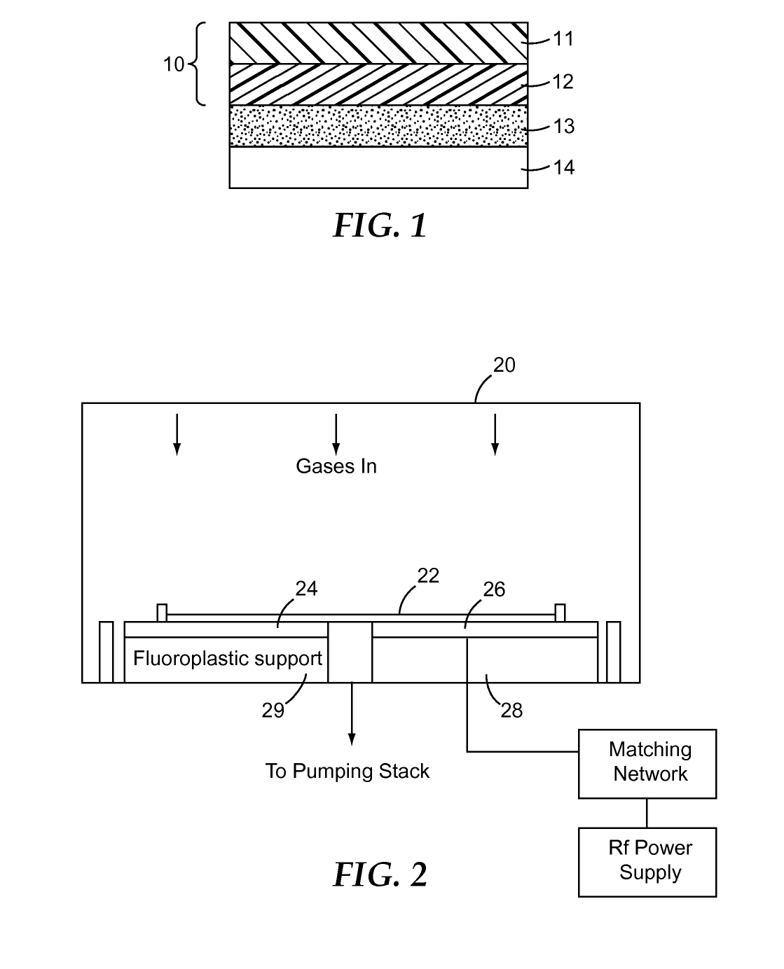

One exemplary embodiment of the present application is shown in FIG. 1. A hydrophilic marking film 10 includes a protective layer 11 and a film 12. The film 12 can be a publicly known film routinely used in marking films, prepared from, for example, a vinyl chloride resin, an acrylic resin, a polyolefinic resin, a polyester resin, a polyurethane resin, and the like, or mixtures thereof. A colorant such as a dye or a pigment, a UV absorbent for improving the weather resistance properties, a thermal stabilizer, or a plasticizer for improving pliability can be added to the resin. In addition, a multilayer film obtained by overlaying a number of resin layers so as to form a single film can also be utilized. Moreover, the marking film 10 may be disposed upon a surface of a retroreflective sheet. Such retroreflective sheets have high night-time visibility, making them useful for constructing traffic signs.

The thickness of the film 12 is not particularly limited as long as the flexibility of the film 12 can be maintained, but is generally within a range of from 10 to 2,000 micrometers, and or even from 20 to 1,000 micrometers.

The protective layer 11 contains 10% or more but less than 40% of carbon, more than 45% but not more than 75% of oxygen, and 15% or more but not more than 32% of silicon in terms of atomic composition. By making the atomic compositions fall within these ranges, a highly hydrophilic marking film can be produced. If the carbon content is less than 10%, the silicon content is greater than 32%, or the oxygen content exceeds 75%, adhesion between the protective layer 11 and the base film tends to be adversely affected, and if the oxygen content is 45% or lower, hydrophilicity is adversely affected. In addition, if the carbon content is 40% or higher or the silicon content is less than 15%, hydrophilicity is adversely affected. These atomic compositions are measured using ESCA surface analysis methods and indicate the percentage of carbon, oxygen and silicon atoms in the protective layer 11. That is, the percentage of carbon, oxygen and silicon atoms in the protective layer 11 is determined by dividing the number of carbon, oxygen or silicon atoms by the total number of atoms.

A thickness of the protective layer 11 is generally from 10 to 1,000 nanometers, or even from 20 to 500 nanometers. If the protective layer 11 is too thin, the desired level of hydrophilicity may not be achieved, but if the protective layer 11 is too thick, the time required to deposit the protective layer 11 lengthens.

The hydrophilicity of the protective layer 11 is generally such that, at the time of application, the contact angle with water falls within a range of 25° or more but less than 70°. The contact angle with water is a value obtained by using a CA-Z type contact angle meter manufactured by Kyowa Interface Science Co., Ltd. If the contact angle with water is 70° or higher, hydrophilicity may be too low and contamination resistance is adversely affected. The contact angle with water of the protective layer generally is stable, that is to say that it falls within the desired range mentioned above immediately after the time of application to form the protective layer 11, as well as after a period of time (for example, two months or one year) following application. In addition, it is desirable that the contact angle with water, relative to that immediately following application, increases by 50% or less, or even 20% or less.

The contamination resistance properties of the protective layer 11 desirably may be such that color difference after being left outdoors for a long period (for example, two months, four months, or one year) is 20 or lower, 10 or lower, or even 5 or lower. In addition, the surface gloss retention rate of the protective layer 11 desirably may be 40% or higher, 60% or higher, or even 80% or higher after being left outdoors for a long period (for example, two months, four months, or one year).

The protective layer 11 is generally deposited on the surface of the film 12 by a chemical vapor deposition (CVD) method, and generally by a plasma CVD method.

FIG. 2 illustrates a system for depositing a protective layer on a film according to the CVD method. The system includes electrodes 24 and 26, one or both of which are powered by RF (typically only one is powered, but both may be powered such that they are 180° out of phase and have what is known in the art as a push-pull configuration) and a grounded reaction chamber 20, which has a surface area greater than that of the powered electrodes. A film 22 is placed proximate to the electrodes, an ion sheath is formed around the powered electrode, and a large electric field is established across the ion sheath. The electrodes 24 and 26 are insulated from the chamber 20 by fluoroplastic supports 28 and 29.

The reaction chamber 20 is evacuated to remove most air, such as by means of vacuum pumps at a pumping stack connected to the chamber 20. Aluminum is a desirable material for chamber 20 due to aluminum's low sputter yield, which means that very little contamination of the protective layer occurs from the aluminum chamber surfaces. However, other suitable materials, such as graphite, copper, glass or stainless steel, may be used.

It should be noted that what is shown as chamber 20, can be any means of providing a controlled environment that is capable of evacuation, containment of gas introduced after evacuation, plasma creation from the gas, ion acceleration, and film deposition. In the embodiment shown in FIG. 2, chamber 20 is constructed in a manner sufficient to allow for evacuation of a chamber interior and for containment of a fluid for plasma creation, ion acceleration, and protective layer deposition.

The desired process gases are supplied from storage through an inlet tube. A stream of gas is distributed throughout the chamber. Chamber 20 is closed and partially evacuated to the extent necessary to remove species that might contaminate the protective layer. The desired gas (e.g., a gas containing carbon, silicon, and oxygen) is introduced into chamber 20 at a desired flow rate, which depends on the size of the reactor and the amount of film in the reactor. Such flow rates must be sufficient to establish a suitable pressure at which to carry out plasma CVD, typically 0.13 Pa to 130 Pa (0.001 Ton to 1.0 Ton). For a reactor that has an inner diameter of approximately 55 cm and a height of approximately 20 cm, the flow rates are typically from about 50 to about 500 standard cubic centimeters per minute (sccm).

Plasma is generated and sustained by means of a power supply (an RF generator operating at a frequency in the range of 0.001 to 100 MHz). To obtain efficient power coupling (i.e. wherein the reflected power is a small fraction of the incident power), the impedance of the plasma load can be matched to the power supply by means of matching network including two variable capacitors and an inductor, available from RF Power Products, Kresson, N.J., as Model # AMN 3000. A description of such networks can be found, for example, in Brian Chapman, Glow, Discharge Processes, 153, (John Wiley & Sons. New York 1980).

The RF power source powers the electrode with a typical frequency in the range of 0.01 to 50 MHz, typically 13.56 MHz or any whole number (e.g. 1, 2, or 3) multiple thereof. This RF power is supplied to the electrode to create a plasma rich in silicon, carbon, and oxygen from the gas within the chamber that is rich in carbon, silicon, and oxygen. The RF power source can be an RF generator such as a 13.56 MHz oscillator connected to the electrode via a network that acts to match the impedance of the power supply with that of the transmission line (which is usually 50 ohms resistive) so as to effectively transmit RF power through a coaxial transmission line.

Upon application of RF power to the electrode, the plasma is established. In an RF plasma, the powered electrode becomes negatively biased relative to the plasma. This bias is generally in the range of 100 to 1500 volts. This biasing causes ions within the plasma rich in silicon, carbon, and oxygen to accelerate toward the electrode to form an ion sheath. Accelerating ions form a film rich in silicon, carbon, and oxygen on the substrate in contact with electrode.

The depth of the ion sheath ranges from approximately 1 mm (or less) to 50 mm and depends on the type and concentration of gas used, pressure applied, and relative size of the electrodes. For example, reduced pressures will increase the size of the ion sheath, as will having different sized electrodes. When the electrodes are different sizes, a larger (i.e., deeper) ion sheath will form around the smaller electrode. Generally, the larger the difference in electrode size, the larger the difference in the size of the ion sheaths. Also, increasing the voltage across the ion sheath will increase ion bombardment energy.

Deposition of the protective layer typically occurs at rates ranging from about 1 to 100 nm/second (about 10 to 1000 Angstroms per second (A/sec)) depending on conditions including pressure, power, concentration of gas, types of gases, relative size of electrodes, etc. In general, deposition rates increase with increasing power, pressure, and concentration of gas, but the rates will approach an upper limit.

In the present aspect, the protective layer 11 may be deposited by the CVD method using an organic silicon compound. Suitable organic silicon compounds include, for example, compounds containing carbon-silicon bonds and/or carbon-alkoxide bonds such as trimethoxysilane, tetramethoxysilane, methyl(trimethoxy)silane, dimethyl(dimethoxy)silane, tetraethoxysilane, ethyl(triethoxy)silane, methyl(triethoxy)silane, diethyl(diethoxy)silane, methylethyl(diethoxy)silane and the like. However, from the perspectives of stability and ease of handling, hexamethyldisiloxane, tetramethyldisiloxane and tetramethylsilane (TMS), which are organic silicon compounds having four or more carbon atoms in the molecule, are desirable. In addition to organic silicon compounds, hydrocarbons such as acetylene, methane, butane, butadiene, benzene, methylcyclopentadiene, pentadiene, styrene, napthalene or azulene, silanes such as SiH₄ or Si₂H₂, hydrogen, nitrogen, oxygen, fluorine, sulfur, titanium, copper, and the like may be used.

It is possible to produce the protective layer 11 in two or more steps by depositing one protective layer by the plasma CVD method and then repeating the same procedure to deposit another protective layer over the protective layer deposited in the first step. By producing the protective layer 11 using two or more steps, it is easy to control the hydrophilicity and produce an optically transparent protective layer.

Even after the protective layer 11 has been deposited, the hydrophilic marking film 10 generally has appropriate extensibility and is able to be applied to a curved substrate. The ratio of the extensibility (extensibility retention) of a film having a protective layer formed thereupon to that of a film not having a protective layer formed thereupon may be 0.40, 0.60, or even 0.80 or higher. Another way of stating this is to say the film with a protective layer retains 40%, 60% or 80% or higher of the extensibility of the same film without the protective layer. Low extensibility retention has an adverse effect on curved surface followability.

In the hydrophilic marking film 10 of the present aspect, an adhesive layer 13 may be provided, as illustrated in FIG. 1. The adhesive layer 13 may be produced using a pressure sensitive adhesive that contains an adhesive polymer. Typical additives added to adhesive layers such as pigments, antioxidants and tackifiers, may be added to the adhesive layer 13.

The adhesive layer 13 may be laminated with a release sheet 14, as illustrated in FIG. 1, in order to protect the surface thereof. The release sheet 14 may be obtained by, for example, treating a surface of a paper or a film with a release agent.

### EXAMPLES

Although examples and comparative examples are described below to explain the present disclosure in further detail, the present disclosure is not limited by these examples.

### Example 1

A protective layer was deposited by a plasma CVD method on a surface of a white acrylic film (SCOTCHCAL™ film AF1000ES manufactured by Sumitomo 3M Ltd.). A parallel plate capacitively coupled plasma reactor manufactured by 3M was used to produce the protective layer. After placing a 210 mm×300 mm white acrylic film on the electrode and closing the chamber, depressurization was started, and when the pressure reached approximately 10 mTorr, the types of gases (“Gas” in the tables) and the flow rates of each gas (“Flow rate” in the tables) were set as shown under “Plasma CVD layer 1” in Table 1, and the gases were then fed into the chamber. Next, the process pressure was set to 75 mTorr, the RF power (“Power” in Table 1) and the time (“Time” in Table 1) were set as shown under “Plasma CVD layer 1” in Table 1, and treatment of the first layer was carried out using a plasma CVD method at a frequency of 13.56 MHz. Following the treatment, the RF power was stopped, the gas supply was stopped and, with the vacuum inside the chamber maintained, the types of gases and the flow rates of each gas were set as shown under “Plasma CVD layer 2” in Table 1, and the gases were then fed into the chamber. Next, the process pressure was set to 75 mTorr, the RF power and the time were set as shown under “Plasma CVD layer 2” in Table 1, and treatment of the second layer was carried out using the plasma CVD method at a frequency of 13.56 MHz. Following the treatment, the RF power and the gas supply were stopped, the chamber was returned to atmospheric pressure and then opened, the white acrylic film was recovered, and the marking film of Example 1 was obtained.

TABLE 1

| | | | Plasma CVD layer 1 | | | | Plasma CVD layer 2 | | | |
|---|---|---|---|---|---|---|---|---|---|---|
| | | | | Flow rate | Power | Time | | Flow rate | Power | Time |
| | Film | Color | Gas | (sccm) | (W) | (min.) | Gas | (sccm) | (W) | (min.) |
| Example 1 | Acrylic | White | TMS/O₂ | 150/50 | 2000 | 2 | O₂/2% | 500/500 | 1000 | 1 |
| | | | | | | | SiH₄(Ar) | | | |
| Example 2 | Acrylic | Clear | TMS/O₂ | 150/500 | 2000 | 2 | O₂/2% | 500/500 | 1000 | 1 |
| | | | | | | | SiH₄(Ar) | | | |
| Example 3 | Acrylic | Clear | TMS/O₂ | 150/50 | 2000 | 2 | O₂/2% | 500/500 | 1000 | 1 |
| | | | | | | | SiH₄ (Ar) | | | |
| Example 4 | PET | Clear | TMS/O₂ | 75/250 | 200 | 0.5 | TMS/O₂ | 10/500 | 500 | 1 |
| Example 5 | PET | Clear | TMS/O₂ | 75/250 | 500 | 0.5 | TMS/O₂ | 10/500 | 500 | 1 |
| Example 6 | PET | Clear | TMS/O₂ | 75/250 | 500 | 1.5 | TMS/O₂ | 10/500 | 500 | 1 |
| Example 7 | PVC | White | TMS/O₂ | 75/250 | 200 | 0.5 | TMS/O₂ | 10/500 | 500 | 1 |
| Example 8 | PVC | Clear | TMS/O₂ | 75/250 | 200 | 0.5 | TMS/O₂ | 10/500 | 500 | 1 |
| Example 9 | Acrylic | White | TMS/O₂ | 75/250 | 200 | 0.5 | TMS/O₂ | 10/500 | 500 | 1 |
| Example 10 | Acrylic | Clear | TMS/O₂ | 75/250 | 500 | 0.5 | TMS/O₂ | 10/500 | 500 | 1 |
| Example 11 | Acrylic | Clear | C₄H₁₀ | 130 | 200 | 0.5 | TMS/O₂ | 10/500 | 200 | 0.5 |
| Example 12 | Acrylic | Clear | C₄H₁₀ | 130 | 500 | 0.5 | TMS/O₂ | 10/500 | 200 | 0.5 |
| Example 13 | Acrylic | Clear | C₄H₁₀/TMS | 130/25 | 200 | 0.5 | TMS/O₂ | 10/500 | 200 | 0.5 |
| Example 14 | Acrylic | Clear | C₄H₁₀/TMS | 130/75 | 200 | 0.5 | TMS/O₂ | 10/500 | 200 | 0.5 |
| Comparative | Acrylic | White | None | — | None | — | None | — | None | — |
| Example 1 | | | | | | | | | | |
| Comparative | Acrylic | Clear | None | — | None | — | None | — | None | — |
| Example 2 | | | | | | | | | | |
| Comparative | PET | Clear | None | — | None | — | None | — | None | — |
| Example 3 | | | | | | | | | | |
| Comparative | PVC | White | None | — | None | — | None | — | None | — |
| Example 4 | | | | | | | | | | |
| Comparative | PVC | Clear | None | — | None | — | None | — | None | — |
| Example 5 | | | | | | | | | | |
| Comparative | PVC | White | None | — | None | — | None | — | None | — |
| Example 6 | | | | | | | | | | |
| Comparative | PVC | Clear | None | — | None | — | None | — | None | — |
| Example 7 | | | | | | | | | | |
| Comparative | Acrylic | White | None | — | None | — | None | — | None | — |
| Example 8 | | | | | | | | | | |
| Comparative | Acrylic | Clear | None | — | None | — | None | — | None | — |
| Example 9 | | | | | | | | | | |
| Comparative | Acrylic | Clear | C₄H₁₀/TMS | 130/25 | 200 | 0.5 | None | — | None | — |
| Example 10 | | | | | | | | | | |
| Comparative | Acrylic | Clear | C₄H₁₀/TMS | 130/10 | 200 | 0.5 | None | — | None | — |
| Example 11 | | | | | | | | | | |

### Examples 2 and 3

The marking films in these examples were prepared in the same way as in Example 1, except that a transparent acrylic film (SCOTCHCAL™ film AF 1900 manufactured by Sumitomo 3M Ltd.) was used instead of a white acrylic film) and the plasma CVD treatment conditions were as shown in Table 1.

### Examples 4, 5 and 6

A pigment premix solution was obtained by adding 40 parts by mass of methyl isobutyl ketone to 10 parts by mass (in terms of solid content) of a hard polymer 1 (composition: methyl methacrylate:butyl methacrylate:dimethylaminoethyl methacrylate=60:34:6; molecular weight: 70,000; glass transition temperature: 66° C.; ethyl acetate solution having a solid content of 40%) and 50 parts by weight of a titanium oxide 1 (TiPure R960, manufactured by DuPont) and then agitating for 10 minutes in a paint shaker (ARE250, manufactured by Thinky) Next, a white adhesive composition solution was prepared by blending an adhesive polymer 1 with the pigment premix solution so as to contain 50 parts by mass of the titanium oxide 1 and 10 parts by mass of the hard polymer 1 per 100 parts by mass of the adhesive polymer 1 (composition: butyl methacrylate:acrylic acid=96:4; molecular weight: 580,000; glass transition temperature: −50° C.; ethyl acetate/toluene solution having a solid content of 42%). Furthermore, 0.2 parts by mass (in terms of solid content) of a bisamide-based crosslinking agent 1 (1,1′-isophthaloyl bis(2-methylaziridine)) was added to 100 parts by mass of the adhesive polymer 1. This white adhesive composition solution was coated on a release paper using a knife coater so as to have a thickness of 30 micrometers after drying and then heated for 5 minutes at 90° C. so as to obtain a white adhesive layer. Next, one face of an infrared ray-reflecting multilayer film having a thickness of 50 micrometers (manufactured by 3M) was subjected to corona treatment, and the corona-treated face and the above-mentioned white adhesive layer were bonded together so as to obtain the films used in these examples.

A protective layer was deposited on the surface of the film prepared using the above-mentioned procedure by the plasma CVD method. A Plasmatherm 7000 parallel plate capacitively coupled plasma reactor (manufactured by Oerlikon) was used in the preparation of the protective layer. After placing a 210 mm×300 mm film on the electrode and closing the chamber, the marking films of these examples were obtained using a similar procedure to that in Example 1, under the conditions shown in Table 1.

### Example 7

The marking film in this example was prepared in the same way as in Example 1, except that a white PVC film (SCOTCHCAL™ film JS 1000A, manufactured by Sumitomo 3M Ltd.) was used as the film, and the plasma CVD treatment conditions were as shown in Table 1.

### Example 8

The marking film in this example was prepared in the same way as in Example 1, except that a transparent PVC film (SCOTCHCAL™ film JS 1900A, manufactured by Sumitomo 3M Ltd.) was used as the film and the plasma CVD treatment conditions were as shown in Table 1.

### Example 9

The marking film in this example was prepared in the same way as in Example 1, except that a white acrylic film (SCOTCHCAL™ film AF 1000ES, manufactured by Sumitomo 3M Ltd.) was used as the film and the plasma CVD treatment conditions were as shown in Table 1.

### Examples 10, 11, 12, 13, and 14

The marking films in these examples were prepared in the same way as in Example 1, except that a transparent acrylic film (SCOTCHCAL™ film AF1900, manufactured by Sumitomo 3M Ltd.) was used as the film and the plasma CVD treatment conditions were as shown in Table 1. Moreover, C₄H₁₀ was butane.

### Comparative Example 1

A white acrylic film (SCOTCHCAL™ film AF 1000ES, manufactured by Sumitomo 3M Ltd.) was used as the marking film in this comparative example.

### Comparative Example 2

A transparent acrylic film (SCOTCHCAL™ film AF 1900, manufactured by Sumitomo 3M Ltd.) was used as the marking film in this comparative example.

### Comparative Example 3

The marking film in this comparative example was prepared in the same way as in Example 4, except that the procedure for depositing a protective layer by the plasma CVD method was omitted.

### Comparative Example 4

A white PVC film (SCOTCHCAL™ film JS 1000A, manufactured by Sumitomo 3M Ltd.) was used as the marking film in this comparative example.

### Comparative Example 5

A transparent PVC film (SCOTCHCAL™ film JS 1900A, manufactured by Sumitomo 3M Ltd.) was used as the marking film in this comparative example.

### Comparative Example 6

A white PVC film (SCOTCHCAL™ film JS 1000A, manufactured by Sumitomo 3M Ltd.) was used as the marking film in this comparative example.

### Comparative Example 7

A transparent PVC film (SCOTCHCAL™ film JS 1900A, manufactured by Sumitomo 3M Ltd.) was used as the marking film in this comparative example.

### Comparative Example 8

A white acrylic film (SCOTCHCAL™ film AF 1000ES, manufactured by Sumitomo 3M Ltd.) was used as the marking film in this comparative example.

### Comparative Example 9

A transparent acrylic film (SCOTCHCAL™ film AF 1900, manufactured by Sumitomo 3M Ltd.) was used as the marking film in this comparative example.

### Comparative Examples 10 and 11

The marking films in these examples were prepared in the same way as in Example 1, except that a transparent acrylic film (SCOTCHCAL™ film AF 1900, manufactured by Sumitomo 3M Ltd.) was used as the film and the plasma CVD treatment conditions were as shown in Table 1. Moreover, C₄H₁₀ was butane.

The contact angle with water of the marking film in the above examples was measured as follows. A marking film cut to 70 mm×30 mm was bonded to an aluminum plate, water droplets were dropped onto the surface of the marking film, and the contact angle with water was measured using a CA-Z type contact angle meter manufactured by Kyowa Interface Science Co., Ltd. according to the procedure described in the manual of the contact angle meter. The water used was purified water obtained by distilling deionized water. The measurement was carried out 10 times, and the average value of these measurements was used. The initial value was the value obtained at the time of application. In addition, the same contact angle measurement was carried out at fixed intervals (one month, two months, four months, five months and one year) after the marking films were left outside. Moreover, the surfaces of the films were not cleaned after being exposed outside. The results are shown in Table 2.

The color difference of the marking films in the above examples was measured as follows. The L*, a* and b* values were measured using a color meter (E90, manufactured by Nippon Denshoku Industries Co., Ltd.). The color difference was determined by calculating the color difference (dE) using the following formula, with the measured values following plasma CVD treatment being L1*, a1* and b1*, and the measured values after the films were left outside for one month, two months, four months, five months and one year being L2*, a2* and b2*. Moreover, the surfaces of the films were not cleaned after being exposed outside. The results are shown in Table 2.

Color difference=[(L2*−L1*)²+(a2*−a1*)²+(b2*−b1*)²]^{1/2}

The surface gloss retention of the marking films in the above examples was measured as follows. A 60° surface gloss following plasma CVD treatment was measured using a portable gloss meter (GMX-202, manufactured by Murakami Color Research Laboratory Co., Ltd.). The surface gloss was also measured in the same way after leaving the marking films outside for one month, two months, four months, five months and one year. Moreover, the surfaces of the films were not cleaned after being exposed outside. The measurement was carried out three times, and the average value of these measurements was used. Using these surface gloss measurements, the surface gloss retention was determined according to the following formula. The results are shown in Table 2.

Surface gloss retention (%)=[(surface gloss after being left outside)/(surface gloss after treatment)]×100.

TABLE 2

| | Contact angle(degree) | | | dE | | | | | Gloss retention (%) | | | | |
|---|---|---|---|---|---|---|---|---|---|---|---|---|---|
| | Initial | 2 months | 1 yr | 1 month | 2 months | 4 months | 5 months | 1 yr | 1 month | 2 months | 4 months | 5 months | 1 yr |
| Example 1 | 42 | | 30 | | | 1.03 | | 1.86 | | | 95 | | 91 |
| Example 2 | 40 | | 32 | | | 0.83 | | 0.28 | | | 92 | | 110 |
| Example 3 | 37 | | 40 | | | 1.48 | | 1.14 | | | 87 | | 93 |
| Example 4 | 60 | 55 | | 0.16 | 0.16 | | | | 101 | 102 | | | |
| Example 5 | 57 | 56 | | 0.2 | 0.24 | | | | 92 | 102 | | | |
| Example 6 | 62 | 66 | | 0.26 | 3.09 | | | | 103 | 106 | | | |
| Example 7 | 39 | | | 0.9 | | | | | 101 | | | | |
| Example 8 | 35 | | | 1.98 | | | | | 91 | | | | |
| Example 9 | 31 | | | 0.79 | | | | | 97 | | | | |
| Example 10 | 37 | | | 1.36 | | | | | 92 | | | | |
| Example 11 | 40 | | | | | | | | | | | | |
| Example 12 | 44 | | | | | | | | | | | | |
| Example 13 | 45 | | | | | | | | | | | | |
| Example 14 | 40 | | | | | | | | | | | | |
| Comparative | 89 | | 60 | | | 10.55 | | 8.54 | | | 78 | | 86 |
| Example 1 | | | | | | | | | | | | | |
| Comparative | 83 | | 60 | | | 2.79 | | 2.47 | | | 77 | | 93 |
| Example 2 | | | | | | | | | | | | | |
| Comparative | 82 | 71 | | 0.44 | 1.25 | | | | 100 | 98 | | | |
| Example 3 | | | | | | | | | | | | | |
| Comparative | 82 | | | | | | 4.37 | | | | | 100 | |
| Example 4 | | | | | | | | | | | | | |
| Comparative | 80 | | | | | | 2.24 | | | | | 92 | |
| Example 5 | | | | | | | | | | | | | |
| Comparative | 82 | | | 3.09 | | | | | 88 | | | | |
| Example 6 | | | | | | | | | | | | | |
| Comparative | 80 | | | 3.82 | | | | | 83 | | | | |
| Example 7 | | | | | | | | | | | | | |
| Comparative | 87 | | | 4.37 | | | | | 89 | | | | |
| Example 8 | | | | | | | | | | | | | |
| Comparative | 88 | | | 2.27 | | | | | 86 | | | | |
| Example 9 | | | | | | | | | | | | | |
| Comparative | 92 | | | | | | | | | | | | |
| Example 10 | | | | | | | | | | | | | |
| Comparative | 92 | | | | | | | | | | | | |
| Example 11 | | | | | | | | | | | | | |

Surface elemental analysis of the marking films in the above examples was carried out using an Axis Ultra photoelectron spectrometer manufactured by Kratos with an Al mono anode operating at 150 W. The results are shown in Table 3.

TABLE 3

| | C | O | Si |
|---|---|---|---|
| Example 1 | 23.2 | 49.9 | 26.9 |
| Example 2 | 22.4 | 52.8 | 24.8 |
| Example 3 | 30.8 | 47.4 | 21.8 |
| Example 4 | 13.5 | 60.4 | 26.1 |
| Example 5 | 13.4 | 61.2 | 25.5 |
| Example 6 | 14 | 60.3 | 25.7 |
| Example 7 | 20.5 | 56.2 | 23.4 |
| Example 8 | 17.5 | 58.9 | 23.6 |
| Example 9 | 17.5 | 56.1 | 26.5 |
| Example 10 | 16.4 | 59.4 | 24.2 |
| Example 11 | 23.1 | 58.3 | 18.6 |
| Example 12 | 27.5 | 55 | 17.5 |
| Example 13 | 29.7 | 53.5 | 16.8 |
| Example 14 | 16.8 | 61.1 | 22.1 |
| Comparative Example 1 | 78.8 | 19.4 | 1.8 |
| Comparative Example 2 | 79.3 | 19.4 | 1.3 |
| Comparative Example 3 | 74.9 | 23.8 | 1.2 |
| Comparative Example 4 | 82.9 | 14.9 | 2.2 |
| Comparative Example 5 | 82.7 | 15.4 | 1.9 |
| Comparative Example 10 | 77.3 | 12.4 | 10.3 |
| Comparative Example 11 | 73 | 13.4 | 13.5 |

The yield strength, breaking strength and extensibility of the marking films in the above examples were measured as follows. A sample was cut to a length of 150 mm and a width of 25 mm. Using a tensilon-type tensile tester (Autograph AGS 100B, manufactured by Shimadzu) at 20° C., the yield strength, breaking strength and extensibility were measured at a grip interval of 100 mm and a tensile speed of 300 mm/min. The measurements were carried out twice, with the average values of these measurements being used as representative values.

The extensibility retention is a ratio of the film extensibility after the plasma CVD treatment to that before the plasma CVD treatment and is determined according to the following formula. These results are shown in Table 4.

Extensibility retention (%)=[(film extensibility after plasma CVD treatment)/(film extensibility before plasma CVD treatment)]×100

TABLE 4

| | Yield | Break | | Elongation |
|---|---|---|---|---|
| | strength | strength | Elongation | retention |
| | (N/in) | (N/in) | (%) | (%) |
| Example 1 | 15 | 20 | 164 | 85 |
| Example 3 | 23 | 20 | 91 | 88 |
| Example 7 | 36 | 28 | 22 | 68 |
| Example 8 | 36 | 37 | 200 | 103 |
| Comparative Example 1 | 13 | 16 | 191 | — |
| Comparative Example 2 | 23 | 21 | 104 | — |
| Comparative Example 4 | 36 | 27 | 32 | — |
| Comparative Example 5 | 36 | 34 | 195 | — |

Although various embodiments and implementations have been described in the present application, except when stated explicitly otherwise, any embodiment of the present application can be produced using any known materials and production methods, including, for example, those described in the prior art.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims.

What is claimed is:

1. A hydrophilic marking film comprising a film and a protective layer, wherein
the protective layer contains 10% or more but less than 40% of carbon, more than 45% but not more than 75% of oxygen, and 15% or more but not more than 32% of silicon in terms of atomic composition, and
the protective layer is formed using plasma Chemical Vapor Deposition (CVD).

2. The hydrophilic marking film according to claim 1, wherein a surface of the protective layer has a contact angle with water of 25° or more but less than 70° at the time of application.

3. The hydrophilic marking film according to claim 1, wherein the surface of the protective layer has a contact angle with water of 25° or more but less than 70°, two months from the time of application.

4. The hydrophilic marking film according to claim 1, wherein the protective layer is formed by a plasma CVD method having two or more steps.

5. A traffic sign having the hydrophilic marking film according to claim 1 disposed on a surface thereof.
